(19) United States
(12) Patent Application Publication
(10) Pub. No.: US 2023/0199062 A1
(43) Pub. Date: Jun. 22, 2023

(54) DATA CENTER WIDE NETWORK STORAGE LOAD BALANCING

(71) Applicant: Sony Interactive Entertainment Inc., Tokyo (JP)

(72) Inventor: Roelof Roderick Colenbrander, Costa Mesa, CA (US)

(21) Appl. No.: 17/560,084

(22) Filed: Dec. 22, 2021

(51) Int. Cl. H04L 67/1029; H04L 67/1097; A63F 13/358; A63F 13/352

(52) U.S. Cl. CPC H04L 67/1029; H04L 67/1097; A63F 13/358; A63F 13/352; A63F 2300/531; A63F 2300/534

(57) ABSTRACT

A method for load balancing. The method including measuring load demands of a plurality of applications between a plurality of compute nodes and a plurality of network storage distributed across a plurality of rack assemblies of one or more data centers. The method including determining a functional load demand for each application in the plurality of applications based on load demands that are measured for the each application between the plurality of compute nodes and the plurality of network storage. The method including assigning a load score to each of the plurality of applications based on a plurality of functional load demands determined for the plurality of applications. The method including load balancing a plurality of gaming sessions of one or more applications executing across the plurality of rack assemblies based on a plurality of load scores associated with the one or more applications facilitating the plurality of gaming sessions.

### TECHNICAL FIELD

The present disclosure is related to learning loads of video games on network storage, assigning load scores based on the learned loads, and distributing gaming sessions of the video games across rack assemblies of a data center of a cloud gaming services based on load scores for the gaming sessions.

### BACKGROUND OF THE DISCLOSURE

In recent years there has been a continual push for online services that allow for online or cloud gaming in a streaming format between a cloud gaming server and a client connected through a network. The streaming format has increasingly become more popular because of the availability of game titles on demand, the ability to execute more complex games, the ability to network between players for multi-player gaming, sharing of assets between players, sharing of instant experiences between players and/or spectators, allowing friends to watch a friend play a video game, having a friend join the on-going game play of a friend, and the like.

Data centers may be configured with multiple computing resources for supporting online or cloud gaming For example, each of the computing resources can be configured to execute video games for game plays and/or gaming sessions of gaming applications that can then be streamed to users. Demand for the computing resources may fluctuate depending on one or more parameters, including demand for a particular video game, the time period for the demand, geographic region of the demand, types of gaming being pursued, etc.

It is difficult to allocate computing resources for the execution of the gaming applications due in part because load measurements of a cloud gaming system may not accurately reflect loads on the cloud gaming system that occur over a period of time. As such, an allocation of computing resources may prove to provide unbalanced loading of various resources within the cloud gaming system.

It is in this context that embodiments of the disclosure arise.

### SUMMARY

Embodiments of the present disclosure relate to learning the actual load of video games on network storage and then assigning load scores to the video games corresponding to the learned and/or actual loads, and using the load scores for optimally distributing gaming sessions of the video games executing on compute nodes of rack assemblies of a data center. Distributing the execution of the video games across the rack assemblies by load scores provides for load balancing across the rack assemblies, such as by minimizing the load on network storage of each of the rack assemblies.

Embodiments of the present disclosure disclose a method for load balancing. The method including measuring load demands of a plurality of applications between a plurality of compute nodes and a plurality of network storage distributed across a plurality of rack assemblies of one or more data centers. The method including determining a functional load demand for each application in the plurality of applications based on load demands that are measured for the each application between the plurality of compute nodes and the plurality of network storage. The method including assigning a load score to each of the plurality of applications based on a plurality of functional load demands determined for the plurality of applications. The method including load balancing a plurality of gaming sessions of one or more applications executing across the plurality of rack assemblies based on a plurality of load scores associated with the one or more applications facilitating the plurality of gaming sessions.

Other embodiments of the present disclosure disclose a non-transitory computer-readable medium storing a computer program for performing a method. The non-transitory computer-readable medium including program instructions for measuring load demands of a plurality of applications between a plurality of compute nodes and a plurality of network storage distributed across a plurality of rack assemblies of one or more data centers. The non-transitory computer-readable medium including program instructions for determining a functional load demand for each application in the plurality of applications based on load demands that are measured for the each application between the plurality of compute nodes and the plurality of network storage. The non-transitory computer-readable medium including program instructions for assigning a load score to each of the plurality of applications based on a plurality of functional load demands determined for the plurality of applications. The non-transitory computer-readable medium including program instructions for load balancing a plurality of gaming sessions of one or more applications executing across the plurality of rack assemblies based on a plurality of load scores associated with the one or more applications facilitating the plurality of gaming sessions.

Still other embodiments of the present disclosure disclose a computer system including a processor and memory coupled to the processor and having stored therein instructions that, if executed by the computer system, cause the computer system to execute a method. The method including measuring load demands of a plurality of applications between a plurality of compute nodes and a plurality of network storage distributed across a plurality of rack assemblies of one or more data centers. The method including determining a functional load demand for each application in the plurality of applications based on load demands that are measured for the each application between the plurality of compute nodes and the plurality of network storage. The method including assigning a load score to each of the plurality of applications based on a plurality of functional load demands determined for the plurality of applications. The method including load balancing a plurality of gaming sessions of one or more applications executing across the plurality of rack assemblies based on a plurality of load scores associated with the one or more applications facilitating the plurality of gaming sessions.

Other embodiments of the present disclosure disclose another method for load balancing. The method including monitoring a plurality of gaming sessions of one or more applications executing across a plurality of rack assemblies. The method including determining a plurality of load scores for the one or more applications associated with plurality of gaming sessions, wherein a corresponding load score of a corresponding application defines a functional load demand on a corresponding network storage. The method including load balancing the plurality of gaming sessions of the one or more applications based on the plurality of load scores associated with the one or more applications facilitating the plurality of gaming sessions.

Still other embodiments of the present disclosure disclose a non-transitory computer-readable medium storing a computer program for performing a method. The non-transitory computer-readable medium including program instructions for monitoring a plurality of gaming sessions of one or more applications executing across a plurality of rack assemblies. The non-transitory computer-readable medium including program instructions for determining a plurality of load scores for the one or more applications associated with plurality of gaming sessions, wherein a corresponding load score of a corresponding application defines a functional load demand on a corresponding network storage. The non-transitory computer-readable medium including program instructions for load balancing the plurality of gaming sessions of the one or more applications based on the plurality of load scores associated with the one or more applications facilitating the plurality of gaming sessions.

Still other embodiments of the present disclosure disclose a computer system including a processor and memory coupled to the processor and having stored therein instructions that, if executed by the computer system, cause the computer system to execute a method. The method including monitoring a plurality of gaming sessions of one or more applications executing across a plurality of rack assemblies. The method including determining a plurality of load scores for the one or more applications associated with plurality of gaming sessions, wherein a corresponding load score of a corresponding application defines a functional load demand on a corresponding network storage. The method including load balancing the plurality of gaming sessions of the one or more applications based on the plurality of load scores associated with the one or more applications facilitating the plurality of gaming sessions.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 is a diagram of a system for providing gaming over a network between one or more compute nodes located at one or more data centers, and is further configured for learning the actual loads of video games on network storage of a rack assembly, wherein the actual loads can be used for distribution of gaming sessions of the video games across rack assemblies of a data center, in accordance with one embodiment of the present disclosure.

FIG. 2A is a diagram of a plurality of rack assemblies including a plurality of compute nodes at a representative data center of a game cloud system, in accordance with one embodiment of the present disclosure.

FIG. 2B is a diagram of a plurality of rack assemblies including a plurality of compute nodes at a representative data center of a game cloud system, wherein each network storage is accessible by a corresponding array of compute nodes, in accordance with one embodiment of the present disclosure.

FIG. 3A is a flow diagram illustrating steps in a method for determining load scores of applications for use in balancing loads of sessions of the applications across rack assemblies of a data center, in accordance with one embodiment of the present disclosure.

FIG. 3B is a flow diagram illustrating steps in a method for using load scores of applications to load balance resources usage when allocating sessions of the applications across rack assemblies of a data center, in accordance with one embodiment of the present disclosure.

FIG. 4 illustrates a distribution and/or allocation of gaming sessions across a plurality of rack assemblies of a data center using load scores for each of the gaming sessions, in accordance with one embodiment of the present disclosure.

FIG. 5 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure described below are set forth without any loss of generality to, and without imposing limitations upon, the claims that follow this description.

Generally speaking, a rack assembly of a data center supporting a game cloud system stores in network storage at least a portion of a catalogue of video games. As sizes of video games increase, it may not be possible for the entire catalogue to be stored at the network storage of the rack assembly. The video games stored on network storage are available to compute nodes in the rack assembly. It may be desired that compute nodes in the rack assembly be overprovisioned with one or more video games for cost and/or performance reasons under the assumption that not every compute node needs peak performance at the same time. For example, a video game may exhibit peak loading of a network in a rack assembly during game startup (e.g., from a saved game or at initiation) or level loading periods that include, for example, the loading of game assets (e.g., three dimensional models, textures, sound effects, initial game files, updates, patches, loading screens, etc.) that are needed when executing the video game. Overprovisioning a network demanding game to multiple compute nodes of a rack assembly may not necessarily overtax networking on the rack assembly as the peak demand of each of the games does not occur simultaneously. Embodiments of the present disclosure provide for learning the actual load of a video game on network storage of a corresponding rack assembly. In that manner, a layer of a cloud controller or cloud management controller can optimally distribute video games and/or gaming sessions (and correspondingly users of those gaming sessions) of those video games across different rack assemblies of a data center depending on a desired strategy. For example, one goal for the distribution of video games may be to minimize the input/output (I/O) load on network storage or network storage servers across one or more rack assemblies of the data center, while also considering a goal of maximizing the number of gaming sessions on a rack assembly and/or across multiple rack assemblies of a data center. In embodiments, the actual load and/or load of a video game on network storage of a rack assembly is learned and/or determined by monitoring traffic counters and/or other metrics between network storage or the network storage server and a corresponding compute node that is executing a corresponding video game and/or application. For example, traffic may be monitored across network interfaces (e.g., PCIe, Ethernet, RoCE, Infiniband, etc.), Peripheral Component Interconnect Express (PCIe) interfaces, etc. The learned load of a video game can be mapped to a load score. Each video game may have a different load score based on the monitored load of the corresponding video game on network storage during one or more periods (e.g., during game startup, level loading, game play operations, etc.). The load scores of one or more video games may be leveraged by a cloud management controller to distribute the video games across one or more rack assemblies of the data center of the game cloud system. In that manner, directed allocation of video games based on load scores throughout the rack assemblies provides for efficient utilization of network storage of each of the rack assemblies, such that network storage of one rack assembly may not be overloaded with network demands from video games while network storage of another rack assembly is minimally loaded with network demands from video games.

With the above general understanding of the various embodiments, example details of the embodiments will now be described with reference to the various drawings.

Throughout the specification, the reference to “application” or “game” or “video game” or “gaming application” or “game title” is meant to represent any type of interactive application that is directed through execution of input commands For illustration purposes only, an interactive application includes applications for gaming, word processing, video processing, video game processing, etc. Further, the terms introduced above are interchangeable.

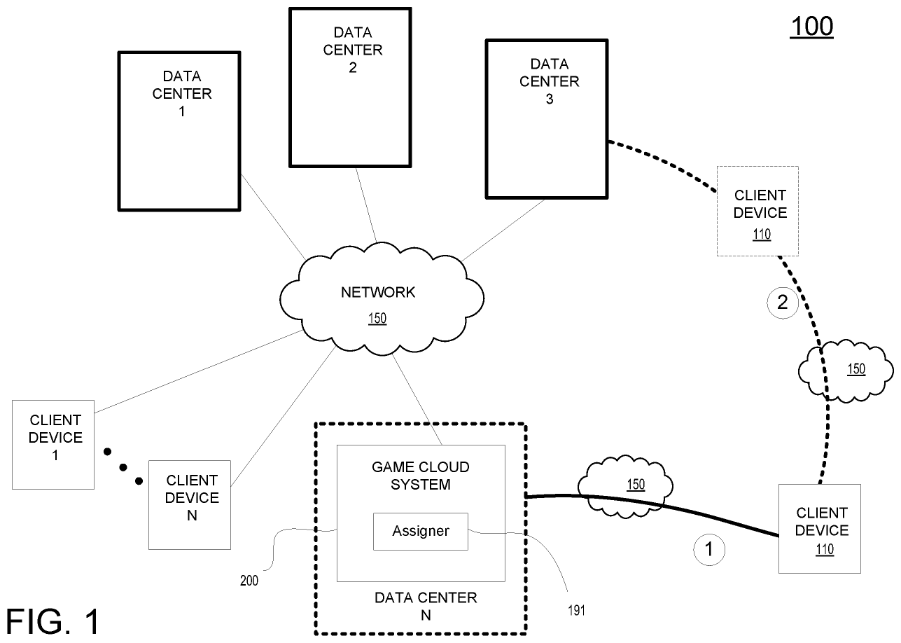

FIG. 1 is a diagram of a system 100 for providing gaming over a network 150 between one or more compute nodes located at one or more data centers of a cloud gaming system, in accordance with one embodiment of the present disclosure. The system is configured to provide gaming over a network between one or more cloud gaming servers, and more specifically is configured allocate video games throughout one or more data centers based on load scores of video games so that demand on network storage across rack assemblies are suitably load balanced when supporting gaming sessions of the video games being executed on the rack assemblies. Cloud gaming includes the execution of a video game at the server to generate game rendered video frames, which are then sent to a client for display.

It is also understood that cloud gaming and/or other services may be performed using physical machines (e.g., central processing units—CPUs—and graphics processing units—GPU), or virtual machines, or a combination of both, in various embodiments (e.g. in a cloud gaming environment or within a stand-alone system). For example, virtual machines (e.g. instances) may be created using a hypervisor of a host hardware (e.g. located at a data center) utilizing one or more components of a hardware layer, such as multiple CPUs, memory modules, GPUs, network interfaces, communication components, etc. These physical resources may be arranged in racks, such as racks of CPUs, racks of GPUs, racks of memory, etc., wherein the physical resources in the racks may be accessed using top of rack switches facilitating a fabric for assembling and accessing of components used for an instance (e.g. when building the virtualized components of the instance). Generally, a hypervisor can present multiple guest operating systems of multiple instances that are configured with virtual resources. That is, each of the operating systems may be configured with a corresponding set of virtualized resources supported by one or more hardware resources (e.g. located at a corresponding data center). For instance, each operating system may be supported with a virtual CPU, multiple virtual GPUs, virtual memory, virtualized communication components, etc. In addition, a configuration of an instance that may be transferred from one data center to another data center to reduce latency. Instant utilization defined for the user or game can be utilized when saving a user's gaming session. The instant utilization can include any number of configurations described herein to optimize the fast rendering of video frames for a gaming session. In one embodiment, the instant utilization defined for the game or the user can be transferred between data centers as a configurable setting. The ability to transfer the instant utilization setting enables for efficient migration of game play from data center to data center in case the user connects to play games from different geo locations.

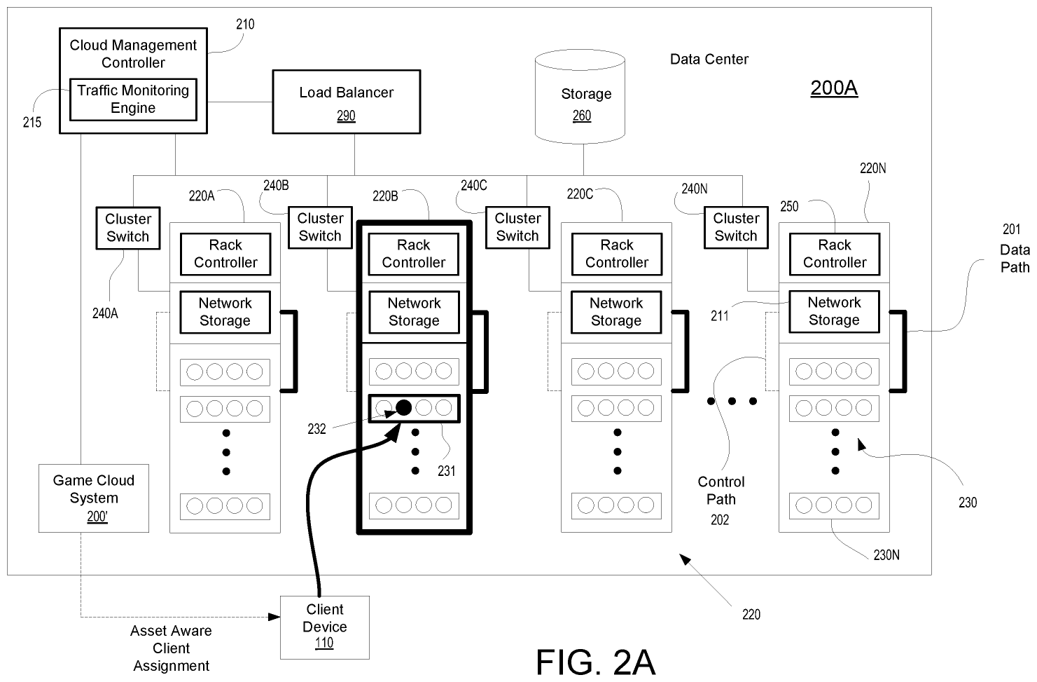

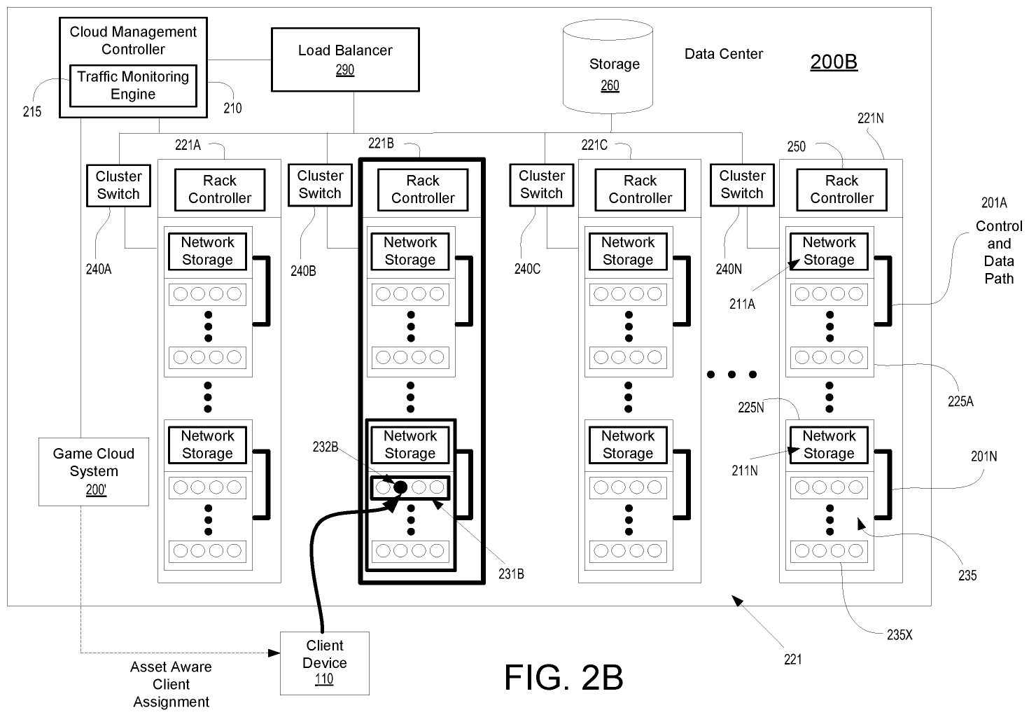

System 100 includes a game cloud system 200 as implemented through one or more data centers (e.g., data centers 1 through N). As shown an instance of game cloud system 200 could be located in data center N that provides management functionality, wherein the management functionality of the game cloud system 200 may be distributed through multiple instances of the game cloud system 200 at each of the data centers. In some implementations, the game cloud system management functionality may be located outside of any of the data centers. For example, management functionality of the game cloud system may be performed by a cloud management controller, as will be further described in FIGS. 2A-2B.

That game cloud system 200 includes an assigner 191 that is configured to assign each of the client devices (e.g., 1-N) to corresponding resources in corresponding data centers. In particular, when client device 110 logs into the game cloud system 200, the client device 110 may be connected with an instance of a game cloud system 109 at data center N, wherein data center N may be geographically closest to client device 110. The assigner 191 is able to perform diagnostic testing to determine available transmit and receive bandwidth to the client device 110. Also, diagnostic testing includes determining latency and/or round trip time between a corresponding data center and a client device 110. Based on the testing, the assigner 191 is able to assign resources to client device 110 with great specificity. For example, the assigner 191 is able to assign a particular data center to the client device 110. In addition, the assigner 191 is able to assign to the client device 110 a particular compute node, of a particular compute sled, of a particular streaming array, of a particular rack assembly. Assignment may be performed based on knowledge of assets (e.g., games) that are available at the compute nodes. Previously, the client device is assigned general to a data center, without further assignment to rack assemblies. In this manner, the assigner 191 is able to assign a client device that is requesting execution of a particular gaming application that is compute intensive to a compute node that may not be running compute intensive applications. In addition, load management of assigning of compute intensive gaming applications as requested by clients may be performed at the assigner 191. For example, the same compute intensive gaming application that is being requested over a short period of time, may be spread across different compute nodes, of different compute sleds in one rack assembly or different rack assemblies to reduce load on a particular compute node, compute sled, and/or rack assembly.

In some embodiments, the assignment may be performed based on machine learning. In particular, resource demand may be predicted for a particular data center, and its corresponding resources. For example, if it can be predicted that a data center will soon be handling many clients running compute intensive gaming applications, then the assigner 191 may assign client device 110 with that knowledge, and assign resources that may not be currently utilizing all of its resource capabilities. To continue this example, it may be that not all rack assemblies and/or compute nodes in a data center are powered on, or they may be in rest mode. When it is predicted that the data center will be ramping-up usage of these rack assemblies and/or compute nodes, then the overall management layer (including the assigner 191) of the data center may instruct appropriate hardware (e.g., rack assemblies and/or compute nodes and/or the like) to wake up and/or undergo power up or power on sequences. In another case, assigner 191 may switch client device 110 from the game cloud system 200 in data center N to resources available in data center 3, in anticipation of increased loading at data center N. In addition, future clients may be assigned to resources in a distributed fashion, such that the load and demand for resources may be distributed throughout the game cloud system, across multiple data centers, across multiple rack assemblies, across multiple compute sleds, and/or across multiple compute nodes. For example, client device 110 may be assigned resources from both game cloud systems on data center N (e.g., over path 1) and data center 3 (e.g., over path 2).

Once the client device 110 is assigned to a particular compute node, of a corresponding compute sled, of a corresponding streaming array, the client device 110 connects to the corresponding data center through the network. That is, the client device 110 may be communicating with a different data center, such as data center 3, than the one performing assignment.

System 100 provides gaming via a game cloud system 200, wherein the game is being executed remote from client device (e.g. thin client) of a corresponding user that is playing the game, in accordance with one embodiment of the present disclosure. System 100 may provide gaming control to one or more users playing one or more games through the cloud game network or game cloud system 200 via network 150 in either single-player or multi-player modes. In some embodiments, the cloud game network or game cloud system 200 may include a plurality of virtual machines (VMs) running on a hypervisor of a host machine, with one or more virtual machines configured to execute a game processor module utilizing the hardware resources available to the hypervisor of the host. Network 150 may include one or more communication technologies. In some embodiments, network 150 may include 5^{th} Generation (5G) network technology having advanced wireless communication systems.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

As shown, the system 100 including game cloud system 200 can provide access to a plurality of gaming applications. In particular, each of the client devices may be requesting access to different gaming applications from the cloud game network. For example, the game cloud system 200 may provide one or more game servers that may be configured as one or more virtual machines executing on one or more hosts to execute a corresponding gaming application. For example, a game server may manage a virtual machine supporting a game processor that instantiates an instance of a gaming application for a user. As such, a plurality of game processors of one or more game servers associated with a plurality of virtual machines is configured to execute multiple instances of one or more gaming applications associated with gameplays of a plurality of users. In that manner, back-end server support provides streaming of media (e.g. video, audio, etc.) of gameplays of a plurality of gaming applications to a plurality of corresponding users. That is, a game server of the game cloud system 200 is configured to stream data (e.g. rendered images and/or frames of a corresponding gameplay) back to a corresponding client device through network 150. In that manner, a computationally complex gaming application may be executing at the back-end server in response to controller inputs received and forwarded by client device. Each server is able to render images and/or frames that are then encoded (e.g. compressed) and streamed to the corresponding client device for display.

In embodiments, each virtual machine defines a resource environment which can support an operating system, upon which a gaming application can be run. In one embodiment, a virtual machine can be configured to emulate the hardware resource environment of a gaming console, with an operating system associated with the gaming console being run on the virtual machine to support the running of game titles which were developed for that gaming console. In another embodiment, the operating system can be configured to emulate a native operating system environment of a gaming console, though the underlying virtual machine may or may not be configured to emulate the hardware of the gaming console. In another embodiment, an emulator application is run on top of the operating system of a virtual machine, the emulator being configured to emulate the native operating system environment of a gaming console so as to support gaming applications and/or video games designed for that gaming console. It should be appreciated that a variety of current and legacy gaming consoles can be emulated in a cloud-based gaming system. In this manner, a user can access game titles from different gaming consoles via the cloud-gaming system.

In one embodiment, cloud game network or game cloud system 200 is a distributed game server system and/or architecture. In particular, a distributed game engine executing game logic is configured as a corresponding instance of a corresponding gaming application. In general, the distributed game engine takes each of the functions of a game engine and distributes those functions for execution by a multitude of processing entities. Individual functions can be further distributed across one or more processing entities. The processing entities may be configured in different configurations, including physical hardware, and/or as virtual components or virtual machines, and/or as virtual containers, wherein a container is different from a virtual machine as it virtualizes an instance of the gaming application running on a virtualized operating system. The processing entities may utilize and/or rely on servers and their underlying hardware on one or more servers (compute nodes) of the cloud game network or game cloud system 200, wherein the servers may be located on one or more racks. The coordination, assignment, and management of the execution of those functions to the various processing entities are performed by a distribution synchronization layer. In that manner, execution of those functions is controlled by the distribution synchronization layer to enable generation of media (e.g. video frames, audio, etc.) for the gaming application in response to controller input by a player. The distribution synchronization layer is able to efficiently execute (e.g. through load balancing) those functions across the distributed processing entities, such that critical game engine components/functions are distributed and reassembled for more efficient processing.

FIG. 2A is a diagram of a plurality of rack assemblies 210 including a plurality of compute nodes at a representative data center 200A of a game cloud system, in accordance with one embodiment of the present disclosure. For example, multiple data centers may be distributed throughout the world, such as in North America, Europe and Japan. FIG. 2A is provided to illustrate an exemplary configuration of a corresponding rack assembly including a network storage that is accessible by compute nodes located on that rack assembly.

The data center 200 includes a plurality of rack assemblies 220 (e.g., rack assemblies 220A through 220N). Each of the rack assemblies includes corresponding network storage and a plurality of compute sleds. For example, representative rack assembly 220N includes network storage 211 and a plurality of compute sleds 230 (e.g., sleds 230A through 230N), and a rack controller 250 configured for internal and external network configuration of components the rack assembly 220N. Other rack assemblies may be similarly configured with or without modification. In particular, each of the compute sleds includes one or more compute nodes providing hardware resources (e.g., processors, CPUs, GPUs, etc.). For example, compute sled 230N in the plurality of compute sleds 230 of rack assembly 220N is shown to include four compute nodes, though it is understood that the rack assembly may include one or more compute nodes. Each rack assembly is coupled to a cluster switch that is configured to provide communication with a management server that is configured for management of the corresponding data center. For example, rack assembly 220N is coupled to cluster switch 240N. The cluster switch also provides communication to external communication networks (e.g., internet, etc.).

In particular, a cluster fabric (e.g., cluster switches, etc.) provides communications between rack assemblies in one or more clusters, distributed storage 270, and a communication network. In addition, the cluster fabric/switches also provide data center supports services, such as management, logging, monitoring, event generation, tracking, etc. Cluster fabric/switches may provide communication to an external communication network via a router system and a communication network (e.g., internet). Also, cluster fabric/switches provide communication to storage 270. A cluster of rack assemblies at a representative data center of a game cloud system may include one or more rack assemblies by design choice. In one embodiment, a cluster includes fifty rack assemblies. In other embodiments, a cluster may include more than or less than fifty rack assemblies.

In one network configuration, each rack assembly provides high speed access to corresponding network storage, such as within a rack assembly. In one embodiment, this high speed access is provided over a PCIe fabric which provides direct access between a compute node and the corresponding network storage. In other embodiments, high speed access is provided over other network fabric topologies and/or networking protocols, including Ethernet, Infiniband, remote direct memory access (RDMA) over Converged Ethernet (RoCE), etc. For example, in rack assembly 220N the high speed access is configured to provide a data path 201 between a particular compute node of a corresponding compute sled to corresponding network storage (e.g., storage 211). In particular, the network fabric (e.g., PCIe fabric) is capable of providing greater than 4 Gigabyte per second (GB/s) network storage bandwidth (e.g., access) per compute node (e.g., of a rack assembly) at non-volatile memory express (NVMe) latencies. Also, a control path 202 is configured for communicating control and/or management information between the network storage 210 and each of the compute nodes.

The streaming rack assemblies are centered around compute nodes, which run gaming applications, video games and/or stream the audio/video of a game session to a one or more clients. Further, within each rack assembly, video game content may be stored on a storage server providing network storage. The network storage is equipped with a large amount of storage and high speed networking to serve many compute nodes. The network storage is equipped with a large amount of storage and high-speed networking to serve many compute nodes. In particular, a storage protocol (e.g., network file system, etc.) would be implemented over the network fabric topology used for accessing network storage. Data may be stored in network storage using file storage, block storage, or object storage techniques based, in part, on the underlying storage protocol being implemented. For example, a PCIe fabric storage protocol may access block storage data from network storage. The network storage may be configured for fast access, but may not be large enough to store a full catalogue of video game titles. As such, allocation of video games onto network storage is performed based on current and predicted further demand of video games. That is, video games are stored on network storage for a corresponding rack assembly in order to support demand for those video games by users of the game cloud system. As such, compute nodes within a rack assembly may be handling gaming sessions for video games, wherein the video games are stored on network storage for ready access and then subsequently loaded onto the compute nodes for execution. Depending on licensing agreements, a video game may be loaded onto network storage for a rack assembly once with subsequent copies loaded onto one or more compute nodes under a multi-user single copy license, or multiple instances of the video game may be loaded onto the network storage that can then be effectively transferred on a one-to-one basis to one or more compute nodes under a single-user single copy license.

The distributed storage 260 provides centralized storing of user data, game data, and game packages that is accessible by compute nodes of each of the clusters 255 of rack assemblies. Distributed storage 260 is scalable such that servers may be added or removed depending on demand, and wherein the storage 260 is able to redistribute and/or reconfigure itself. In addition, distributed storage is configured to provide load balancing, such that data is stored in small chunks across multiple storage servers. Management of the distributed storage can be performed through user interfaces. In particular, distributed storage 250 may be configured to store a full complement of video game titles (e.g., gaming applications) for a game cloud system 200 (e.g., approximately 200 terabytes [TB] of storage for storing the full catalogue of gaming applications). Distributed storage 260 may also be configured to store user and game data for the users of the game cloud system 200. User and game data may include user save data, suspend/resume data for corresponding gaming applications, download data, and others (e.g., imaging, photos, etc.). For purposes of illustration, each user may require approximately 50 gigabytes (GB) of storage for each user. In one embodiment, distributed storage 260 stores of suspend/resume information associated with corresponding game titles (e.g., 8 gigabytes per game title).

As shown, the cloud management controller 210 of the data center 200 communicates with the assigner 191 (shown in FIG. 1) to assign resources to client device 110. In particular, cloud management controller 210 may work with an instance of the game cloud system 200′ and in conjunction with the initial instance of the game cloud system 200 (e.g., of FIG. 1) to assign resources to client device 110. In embodiments, the assignment is performed based on asset awareness, such as knowing what resources and bandwidth are required and that exist at the data center. As such, embodiments of the present disclosure are configured to assign client device 110A to a particular compute node 232A of a corresponding compute sled 231A of a corresponding rack assembly 220B, for illustration.

In addition, the cloud management controller 210 is configured to collect and analyze data (e.g., internal data associated with the game cloud system, and external data including network data, etc.) in order to determine load scores of video games, wherein the load scores can be used for load balancing of network storage usage when allocating gaming sessions across the data center. In particular, the traffic monitoring engine 215 is configured to monitor traffic (e.g., input/output or I/O flow, etc.) and/or other metrics between network storage (e.g., one or more network storage servers) and compute nodes of a rack assembly. For example, traffic monitoring engine 215 may include traffic counters configured for monitoring I/O traffic and/or other metrics between the network storage and compute nodes of the rack assembly. Also, the cloud management controller 210 is configured to track and manage an inventory of all available cloud gaming servers (e.g., compute nodes on corresponding rack assemblies), monitor the cloud gaming servers (e.g., to track which video games are being executed on compute nodes of corresponding rack assemblies), and track state (e.g., in use or not) of the cloud gaming servers. Further, the cloud management controller 210 may be configured to track gaming sessions implemented across the cloud gaming servers of the rack assemblies in the data center.

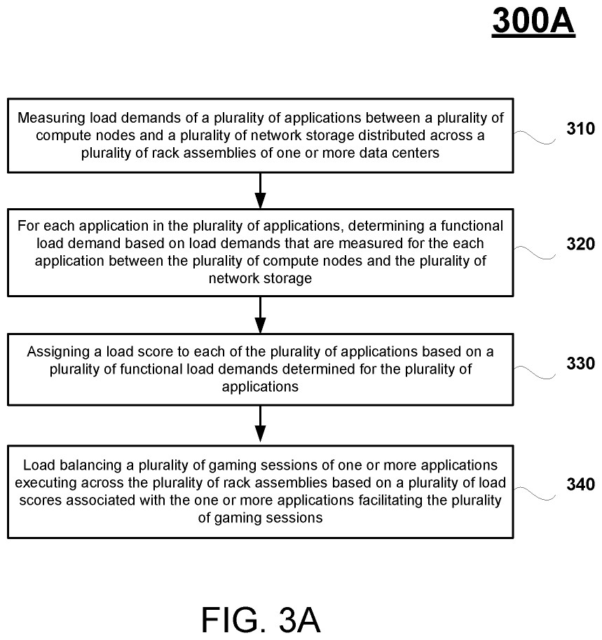

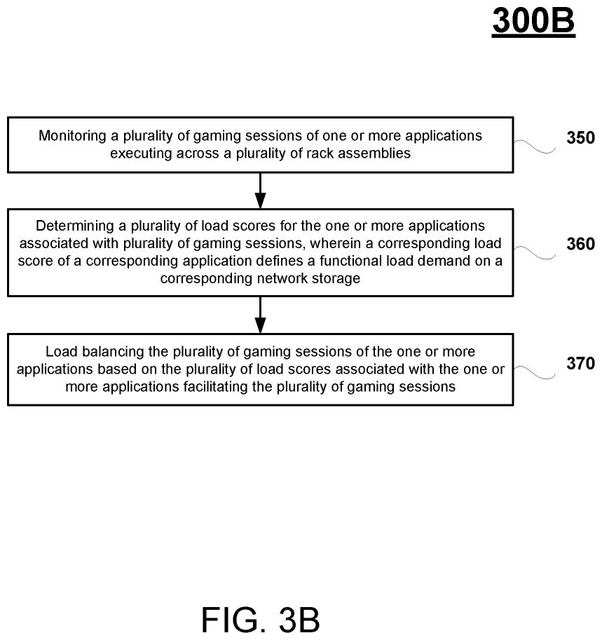

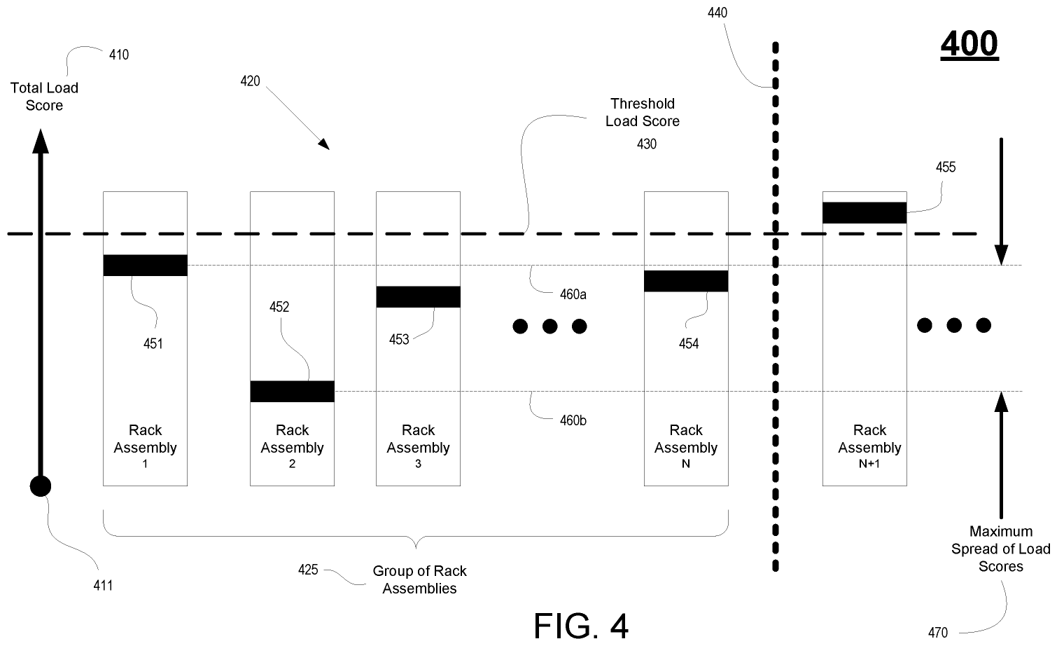

Further, the game cloud system 200 includes a load balancer 290 that is configured to load balance demand on network storage across rack assemblies of one or more data centers based on load scores of video games executing on compute nodes of the rack assemblies to support gaming sessions of those video games. As shown, the load balancer 290 may be included within or be in in communication with the cloud management controller 210 in order to perform the operations necessary for load balancing. In one implementation, the load balancing includes allocation of video games to compute nodes across rack assemblies based on load scores of the video games, as will be further described below in relation to FIGS. 3A, 3B, and 4. The video games are executed on the compute nodes to support gaming sessions, and as such, the load score for a corresponding video game may be assigned to or be associated with the gaming session of that video game. For example, the load balancer 290 may be implemented within the cloud management controller 210 that is configured to manage resources within the game cloud system 200. In particular, the load balancer 290 is configured to allocate video games and/or gaming sessions of video games based on load scores of the video games to compute nodes of corresponding rack assemblies across rack assemblies of one or more data centers of the game cloud system 200.

FIG. 2B is a diagram of a plurality of rack assemblies 221 including a plurality of compute nodes at a representative data center 200B of a game cloud system, wherein each network storage is accessible by a corresponding array of compute nodes, in accordance with one embodiment of the present disclosure. Data center 200B is similar to data center 200A, wherein like numbered components have similar functionality. However, data center 200B has a different configuration of rack assemblies than the rack assemblies in data center 200A, such that network storage is accessed by compute nodes of a single streaming array, as will be described below.

The data center 200 includes a plurality of rack assemblies 221 (e.g., rack assemblies 221A through 221N). Each of the rack assemblies includes one or more streaming arrays, wherein each streaming array includes corresponding network storage and a plurality of compute sleds. For example, representative rack assembly 221N includes streaming arrays 225A through 225N. In one embodiment, rack assembly 221N includes two streaming arrays, wherein each streaming array includes network storage and a plurality of compute sleds. For example, streaming array 225N includes a plurality of compute sleds 235 accessing a network storage 211-N. In particular, each of the compute sleds includes one or more compute nodes providing hardware resources (e.g., processors, CPUs, GPUs, etc.). For example, compute sled 235X of streaming array 225N is shown to include four compute nodes, though it is understood that the rack assembly may include one or more compute nodes.

Each rack assembly is coupled to a cluster switch that is configured to provide communication with a cloud management controller 210 that is configured for management of the corresponding data center, as previously described. For example, rack assembly 221N is coupled to cluster switch 240N. The cluster switch also provides communication to other rack assemblies (e.g., via corresponding cluster switches, and to external communication networks (e.g., internet, etc.).

In one network configuration, each streaming array of a corresponding rack assembly provides high speed access to corresponding network storage, as previously described. This high speed access is provided over a network fabric (e.g., PCIe, Ethernet, RoCE, Infiniband, etc.) which provides direct access between a compute node and the corresponding network storage. Compute nodes may run gaming applications and stream the audio/video of a game session to one or more clients, wherein corresponding network storage (e.g., storage server) holds the gaming application, game data, and user data. For example, in streaming array 225A of rack assembly 221N the high speed access is configured to provide a data and control path 201A between a particular compute node of a corresponding compute sled to corresponding network storage (e.g., storage 211A). Also, path 201N is configured for communicating control and/or management information between the network storage 211N and each of the compute nodes in streaming array 225N.

As previously described, cloud management controller 210 of data center 200B communicates with the assigner 191 to assign resources to client device 110 in support of game cloud system 200′ and/or 200. In embodiments, the assignment is performed based on asset awareness, such as knowing what resources and bandwidth are required and that exist at the data center. As such, embodiments of the present disclosure are configured to assign client device 110 to a particular compute node 232B of a corresponding compute sled 231B of a corresponding streaming array of a rack assembly 221B, for illustration.

Also, the cloud management controller 210, traffic monitoring engine 215, and/or load balancer 290 are configured to collect and analyze data (e.g., internal data associated with the game cloud system, and external data including network data, etc.) in order to determine load scores of video games, wherein the load scores can be used for allocating gaming sessions to compute nodes (i.e., executing video games to support the gaming sessions) of rack assemblies of one or more data centers of game cloud system 200B. In that manner, the demand on network storage by video games executing on compute nodes can be load balanced according to a desired strategy, such as minimizing the load on each of the network storage and/or network storage servers across the rack assemblies. In one embodiment, the video games are distributed across the different rack assemblies in the one or more data centers of the game cloud system 200B based on load scores. For example, video game distribution across rack assemblies (e.g., in network storage) may be performed periodically and/or as a static/off-line operation. That is, the distribution of video games may be based on storage constraints (e.g., size of storage, etc.), and may be based on IO demand, popularity of the video games, size of the video games, etc. In another embodiment, one or more gaming sessions of video games are distributed across compute nodes of different rack assemblies in the one or more data centers of the game cloud system 200B based on load scores. At run-time, the load balancing of gaming sessions is more dynamic to ensure that there are, for example, not too many demanding gaming sessions running simultaneously on a rack assembly, while also utilizing as many compute nodes as possible on that rack assembly, and correspondingly across all rack assemblies of data centers. When compute nodes go unused the data center may not be utilized at its maximum capacity, and thereby disappointing some users, such as when users are denied gaming sessions and/or are on gaming sessions that are performing poorly due to mismanagement of gaming session allocation across the rack assemblies of a data center.

With the detailed description of the various modules of the system 100 and data centers 200A and 200B of FIGS. 1, 2A, and 2B, flow diagram 300A of FIG. 3A discloses a method for load balancing demand on network storage of a game cloud system, in accordance with one embodiment of the present disclosure. In particular, flow diagram may be implemented to determine load scores of applications that reflect the demand on network storage by each application. The load scores may be used when allocating the applications to compute nodes on rack assemblies of one or more data centers of the game cloud system. In that manner, the directed allocation of applications to compute nodes may achieve load balancing of the demand on network storage by minimizing loads across all the network storage of the rack assemblies. Flow diagram 300A may be implemented within a back-end server (e.g., within the game cloud system 200 in a cloud management controller 210 and/or load balancer 290, previously described.

As previously described, a game cloud system includes one or more data centers, wherein each data center includes a plurality of rack assemblies. Further, each of the rack assemblies includes network storage, including one or more network storage servers. Each of the rack assemblies includes a plurality of compute nodes. The network storage of a corresponding rack assembly stores at least a portion of a catalogue of video games offered by the game cloud system. The video games of network storage of the corresponding rack assembly are available to compute nodes on the rack assembly, wherein a video game may be executed on a corresponding compute node to support a gaming session (e.g., single-player and/or multi-player) for the video game. In addition, each of the compute nodes may be configured to execute any number of applications, as previously described, such as background applications that are executing during dark times when the demand on resources for the game cloud system are low (e.g., during off peak hours including early morning hours, etc.).

At 310, the method includes measuring and/or determining load demands of a plurality of applications between a plurality of compute nodes and a plurality of network storage distributed across a plurality of rack assemblies of one or more data centers. In that manner, an actual load demand of each application on corresponding network storage of a corresponding rack assembly can be measured and/or determined. That is, the load demand of a corresponding application can be measured over a period of time across multiple network storage and rack assembly combinations to determine the representative load demand for that application on any network storage of any rack assembly.

In particular to determine load demand, data traffic is measured over a plurality of communication channels between a plurality of compute nodes and a plurality of network storage. The compute nodes are distributed across a plurality of rack assemblies of one or more data centers, such as those associated with a game cloud system. More specifically, data traffic is monitored between each compute node of a rack assembly and network storage of that rack assembly. For example, the traffic monitoring engine 215 of the cloud management controller 210 is configured to monitor data traffic between a specific compute node of a rack assembly and corresponding network storage of that rack assembly. Correspondingly, the traffic monitoring engine 215 is configured to monitor data traffic between each of the compute nodes and their corresponding network storage across all of the rack assemblies of one or more data centers of the game cloud system. For illustration, data traffic may be monitored across network interfaces (e.g., PCIe, Ethernet, RoCE, Infiniband, etc.), PCIe interfaces, etc., wherein the data traffic includes input/output (I/O) flow and/or other metrics. Other data may also be captured that provide information related to load demand on network storage, such as through monitoring operating systems executing on compute nodes, or monitoring execution of the application, and others.

At 320, the method includes for each application in the plurality of applications, determining a functional load demand based on load demands that are measured for the each application between the plurality of compute nodes and the plurality of network storage. In particular, the cloud management controller 210 tracks each of the applications that are executing across the plurality of compute nodes, and correspondingly is able to track and is aware of an application executing on a corresponding compute node. More particularly, the cloud management controller 210 tracks usage of the compute nodes in the data center(s), including whether a corresponding compute node is active or inactive, whether a video game is loaded onto the corresponding compute node, whether a gaming session is actively being executed to support a gaming session with a user assigned to the corresponding compute node, etc. In addition, the tracking includes tracking inventory of the cloud gaming servers or compute nodes, including the number of compute nodes in the game cloud system, the number of active compute nodes that are actively supporting gaming session, the number of available compute nodes that are available for assignment to new users requesting to play a corresponding video game. In that manner, the cloud management controller is able to associate data traffic that is measured between a compute node and corresponding network storage to an application that is executing on that compute node. That is, the measured data traffic between a compute node and network storage is associated with a corresponding application, and is an instance or data point of a measured load on network storage for that application.

As such, by monitoring the data traffic of multiple instances of an application executing across multiple compute nodes across multiple rack assemblies, such as over many monitoring cycles, a functional load can be determined for that application. The data traffic may be monitored during at least one of a startup loading period, or a level loading period, or a game operation period, or an updating period, or the like, for a corresponding application, such as a video game. The functional load is representative of the actual load or actual load demand on network storage for that application. That is, the functional load can be associated with the actual load on corresponding network storage of an instance of the application that is executing on a compute node of a rack assembly, wherein the rack assembly includes the network storage.

As such, by monitoring data traffic of each application executing across the plurality of compute nodes of the plurality of rack assemblies of one or more data centers (e.g., of a game cloud system), a corresponding functional load and correspondingly a corresponding actual load demand on network storage can be determined for each of the plurality of applications.

In one embodiment, the functional load demand is an average load demand on network storage for the corresponding application. That is, the average load demand on network storage for a corresponding application includes all periods of operation including peak demand periods, and off-peak demand periods for data traffic that is monitored across multiple compute nodes executing the application.

In one embodiment, the functional load demand is reflective of peak demand of network storage for the application. That is, data traffic that is monitored across multiple compute nodes executing the corresponding application and corresponding network storage is filtered to include only the peak periods of demand on corresponding network storage. As previously described, peak demand on network storage may occur during application or game startup, level load, updates, patches, etc. Typically, operational periods of a video game or application experience less demand on network storage and may not necessarily be included within a peak demand period for network storage. For instance, I/O traffic occurring during video game operational periods may include the transfer of game controller input, character positional data, etc.

At 330, the method includes assigning a load score to each of the plurality of applications based on a plurality of functional load demands determined for the plurality of applications. As previously described, a corresponding functional load is representative of the actual load or load demand on network storage (i.e., of a corresponding rack assembly) for a corresponding application (i.e., executing on a corresponding compute node of the corresponding rack assembly). In that manner, a comparison can be made between functional loads of a plurality of applications. That is, between any two applications their functional loads gives a comparison of their relative loads and/or load demands on network storage of a corresponding rack assembly.

As such, the functional load demands for the plurality of applications can be ranked from lower to higher demand on corresponding network storage. The rankings illustrate relative functional load demand comparisons between applications. That is, applications with functional load demands that show high demand for network storage, at least when compared to the other applications, would be ranked higher than those other applications that show lower demand for network storage. Further, a load score can be assigned to each application based on corresponding functional load demands. For example, between two applications, a first application with a functional load demand that indicates high demand for network storage would receive a higher load score, and a second application with a functional load demand indicating a lower demand for network storage would receive a lower load score. That is, the load score for the first application would be higher than the load score for the second application, which indicates that the first application has a higher demand for network storage than the second application. It is envisioned that any type of scoring system for load scores may be used to indicate demand on network storage, such as higher load scores indicating higher demand on network storage, or lower load scores indicating higher demand on network storage, etc.

At 340, the method includes load balancing a plurality of cloud sessions (e.g., gaming sessions if video games) of one or more applications executing across the plurality of rack assemblies based on a plurality of load scores associated with the one or more applications facilitating the plurality of gaming sessions.

For example, load balancing of a plurality of gaming sessions of one or more video games executing on compute nodes of rack assemblies is performed based on load scores of the video games. In particular, the load balancing includes monitoring of a plurality of gaming sessions across the plurality of rack assemblies of one or more data centers of a game cloud system. As previously described, the cloud management system 210 is configured to monitor gaming sessions supported by video games being executed on compute nodes. A corresponding load score can be determined for each of the plurality of gaming sessions. For example, a load score of a video game can be assigned to a corresponding gaming session supported by an instance of the video game executing on a corresponding compute node. That is, a corresponding application that is executing to facilitate a corresponding gaming session has been previously assigned to a corresponding load score, wherein that load score can be assigned to or be associated with that corresponding gaming session. The method includes determining a plurality of load scores for the one or more applications or video games executed in association with or in support of the plurality of gaming sessions, wherein the plurality of load scores is used when performing the load balancing. Load balancing of gaming sessions is also described in relation to FIG. 3B below.

In one embodiment, load balancing may be performed in anticipation of predicted loads of network storage on the game cloud system. For example, one or more rack assemblies may be partitioned for a specific use, such as executing one or more pre-selected applications during a dark time period, or in anticipation of a new release of a popular video game which indicates high demand by users to play that video game, etc. A dark time period may be one where there is low demand for gaming on the game cloud system, such as in the early morning hours. During a dark time period, the pre-selected applications may be executed to utilize resources that otherwise would sit idle. In particular, a method for performing load balancing includes predicting a plurality of predicted sessions and/or gaming sessions of one or more predicted (e.g., pre-selected for dark time execution) applications across the plurality of rack assemblies. The method includes determining a predicted load score associated with each of the plurality of predicted sessions and/or gaming sessions. As previously described, a corresponding predicted application executing to facilitate a corresponding predicted session and/or gaming session has a corresponding predicted load score that is assigned to the corresponding predicted gaming session. The method includes determining a plurality of predicted load scores associated with the plurality of predicted sessions and/or gaming sessions. Then, the method includes load balancing the plurality of predicted sessions and or gaming sessions across the plurality of rack assemblies based on the plurality of predicted load scores. In that manner, in anticipation of a predicted load on network storage, allocation of predicted sessions and/or gaming sessions to compute nodes and corresponding rack assemblies may be performed based on the predicted load scores of the predicted sessions and/or gaming sessions.

In a further embodiment, the load balancing considers storage capacity, such as capacity of network storage on each of the rack assemblies. That is, the network storage may be storage capacity constrained. As such, the load balancing of video games and/or gaming sessions of video games would consider or be a function of both available storage capacity and anticipated bandwidth (e.g., bandwidth required by anticipated or predicted loads of network storage on the game cloud system) to determine how the game content (e.g., video games and/or gaming sessions of the video games) are distributed across the rack assemblies and/or compute nodes of the rack assemblies of a data center. Other factors may be considered when performing load balancing. For example, popularity of video games may be considered, such that less popular games may not be loaded across all rack assemblies of a data center, or more popular video games may be loaded across a majority or all of the rack assemblies of a data center.

In another embodiment, the load balancing considers multiple factors. For instance, one factor or goal of load balancing is to minimize I/O on a storage server (i.e., network storage), so that the storage server does not run out of I/O capacity. Another factor or goal is to maximize the number of sessions on a rack assembly and/or across multiple rack assemblies of a data center. As such, both of these factors and/or goals are considered when performing load balancing. For illustration of the consideration of these factors when performing load balancing, a given rack assembly may have a certain amount of N compute resources (e.g., compute nodes). More particularly, a given rack assembly may have a certain amount of compute capacity, such as N sessions for the N compute resources. When the video games differ in compute requirements, the N compute nodes may support a variable number of sessions, wherein the variable number may be less than, equal to, or greater than N. As a result, in some cases, a single compute node can support multiple video games and/or multiple gaming sessions of one or more video games, especially when those video games associated with the gaming sessions have lower compute requirements. That is, a compute node can run multiple gaming sessions depending on how demanding each of the gaming sessions is in terms of compute demand (on processing power) and in terms of network storage demand In that manner, when performing load balancing network storage is not overloaded, and the load balancing also does not cause underutilization of a computing.

Consideration of both minimizing I/O on a storage server and maximizing the number of sessions on a rack assembly may be useful when addressing requests for demanding gaming sessions that quickly reduce available compute capacity. For example, if a rack assembly has N compute resources (e.g., compute nodes), when load balancing network storage may become exhausted at less than N sessions (e.g., one-half of N sessions), especially when not considering the number of sessions on the rack assembly. That is, the network storage capacity is exhausted when half of the compute nodes (N/2) have gaming sessions that are associated with highly demanding video games. To avoid this problem, load balancing may consider the goal of maximizing the number of gaming sessions on a rack assembly. As a result, it may be that in an extreme case, gaming sessions associated with highly demanding video games may be denied on the rack assembly in favor of gaming sessions for lower demanding video games. That is, newly requested highly demanding game sessions may be refused because that would cause the loss of essential compute capacity. For example, one highly demanding gaming session may perhaps use 10× more I/O than a less demanding gaming session. In that manner, one user with a highly demanding gaming session may be replaced with ten users playing lower demanding video games. That is, refusing to support a single demanding game session could allow for more less demanding gaming sessions (e.g., ten more) in terms of I/O on the rack assembly.

In still other embodiments, load balancing considers the capabilities of each rack assembly. For example, different generations of a rack assembly may be compatible with all the video game titles and are configured within a data center. In that case, an older Gen1 (i.e., first generation) rack assembly may be able to handle fewer highly demanding gaming sessions when compared to a newer Gen2 (i.e., second generation) rack assembly. As such, the load balancing will consider performance capabilities of computing resources (e.g., rack assemblies, compute nodes, etc.).

In still other embodiments, load balancing may consider still other factors. For example, there could be different I/O demands based on the users controlling the gaming sessions. That is, users with poor internet connections may die more quickly, for instance due to latency spikes, or dropped controller input packets, etc. In that case, those gaming sessions would require more game restarts or level loads or level reloads. On the other hand, very experienced garners may die less in a game and thus require less game restarts or level reloads. On the other hand, very experienced garners may reach new parts of the video game faster, again requiring more level loads. Another factor may be whether the gaming session is for single-player or multi-player mode, which may have different effects on compute demand and/or network storage demand Still other factors may be considered.

With the detailed description of the various modules of the system 100 and data centers 200A and 200B, and flow diagram 300A of FIGS. 1, 2A, 2B, and 3A, flow diagram 300B of FIG. 3B discloses a method for load balancing demand on network storage of a game cloud system, in accordance with one embodiment of the present disclosure. In particular, flow diagram 300B may be implemented for using load scores of applications to load balance resources usage (e.g., demand for network storage) when allocating sessions of the applications (e.g., gaming sessions of video games) across rack assemblies of a data center, in accordance with one embodiment of the present disclosure. For example, the load scores may be used when allocating the applications to compute nodes on rack assemblies of one or more data centers of the game cloud system. In that manner, the directed allocation of applications to compute nodes may achieve load balancing of the demand on network storage by minimizing loads across all the network storage of the rack assemblies. Flow diagram 300B may be implemented within a back-end server (e.g., within the game cloud system 200 in a cloud management controller 210 and/or load balancer 290, previously described.

At 350, the method includes monitoring a plurality of gaming sessions of one or more applications executing across a plurality of rack assemblies. As previously described, a cloud management controller 210 is configured to monitor gaming sessions supported by video games being executed on compute nodes. A corresponding load score can be determined for each of the plurality of gaming sessions, such that a load score of an application or video game may be assigned to or be associated with a corresponding gaming session.

At 360, the method includes determining a plurality of load scores for the one or more applications associated with plurality of gaming sessions. As previously described, a corresponding load score of a corresponding application defines a functional load demand on a corresponding network storage. As previously described, determination of load scores is performed in FIG. 3A, and includes measuring load demands of a plurality of applications between a plurality of compute nodes and a plurality of network storage distributed across a plurality of rack assemblies of one or more data centers. For each application, a corresponding functional load demand on network storage can be determined based on measured load demands for each application. A functional load demand may be an average load demand on network storage, or a demand that is reflective of peak periods of demand for network storage. A corresponding load score may be assigned to each application based on a corresponding functional load demand.

At 370, the method includes load balancing the plurality of gaming sessions of the one or more applications based on the plurality of load scores associated with the one or more applications facilitating the plurality of gaming sessions. That is, the load scores may be leveraged to distribute the applications based on a selected strategy, such as to minimize load demand across network storage of the rack assemblies. In particular, the plurality of gaming sessions may include current gaming sessions, requested gaming sessions, and/or predicted gaming sessions. In that manner, allocation of applications to compute nodes of rack assemblies may be performed based on the load balancing, wherein the applications are executing on the compute nodes to facilitate the gaming sessions.

In one embodiment, the load balancing is performed to assign a video game to a compute node to facilitate a new gaming session of the video game. That is, a requested gaming session for a user is assigned to a compute node for execution of the corresponding video game based on load balancing. The method for load balancing in consideration of the new gaming session includes receiving a request for a new gaming session of a requested application (e.g., video game). The new gaming session is included within the plurality of gaming sessions for purposes of performing load balancing. The method includes assigning the new gaming session of the corresponding application to a compute node of a rack assembly based on the load balancing. That is, the corresponding application is assigned to the compute node to support the requested gaming session.

In one embodiment, load balancing may be performed on a periodic basis, or when new requests for applications are processed. A new distribution of application across rack assemblies may require the suspension of jobs on compute nodes on one or more rack assemblies and the transfer of those jobs to other compute nodes on one or more other rack assemblies. For purposes of illustration when performing load balancing, the job may be in association with a gaming application, wherein the gaming application may be suspended to be started at a later time, or transferred to another compute node for seamless transfer and execution. For example, a state (e.g., configuration) of a compute node during execution of the job is captured and stored. The state is transferred to another compute node, such as on another rack assembly of the same data center, or on a compute node of a different data center. The state is initialized in the other compute node, and the application is then executed on the new compute node using the transferred state in order to resume the job. In one implementation, the job being suspended is suspended at a selected pause or suspend point that is not a predefined suspension point, such as an end of level of a gaming application.

Purely for illustration purposes only, the suspended job may be associated with a game, or video game or gaming application. In particular, an on-going game is paused at any point in the game, and the game is resumed at the same point of the game at some time in the future (e.g., immediately upon transfer when performing load balancing, or at a later time). The game state of the game and the configuration parameters of the compute node while executing the game are captured and saved. That is, the paused game state is saved with data sufficient to reconstruct the state of the game upon resuming the game, such as when transferred to another compute node during load balancing. As such, while the game is paused, the game state is collected and saved to storage, such that the cloud gaming system does not need to store the state in active memory or registers of the hardware. This allows for resumption of the game play at any time and from any compute node. When resuming the game, the game state is loaded on the new compute node tasked to resume the game. Loading of game state may include generating the game state from multiple saved files and data structures, such as that the reconstructed game state will place the compute node in the same or substantially the same state as when the game was paused.

FIG. 4 is a diagram 400 illustrating a distribution and/or allocation of gaming sessions across a plurality of rack assemblies of a data center using load scores for each of the gaming sessions, in accordance with one embodiment of the present disclosure. In particular, a plurality of rack assemblies 420 (e.g., 1-N, N+1 etc.) is shown, wherein the rack assemblies 420 are included within one or more data centers, such as within a game cloud system. Each of the rack assemblies includes network storage, and a plurality of compute nodes. Each of the compute nodes may be configured to execute a corresponding application, such as a video game, etc.

Vertical line 410 illustrates a value of total load score. As previously described, a load score for a corresponding application is representative of a load demand on network storage (e.g., based on a functional load demand) by that application. A total load score for a rack assembly is determined by summing the load scores of applications executing on compute nodes for that rack assembly. As such, a distribution of applications for a given rack assembly may be defined by or associated with a corresponding total load score. Also, the distribution of applications across multiple rack assemblies of one or more data centers may be defined by or associated with total load scores of the multiple rack assemblies, as is shown in FIG. 4.

As shown in FIG. 4, load score values increase moving away from the center 411. Each rack assembly has a corresponding and determined total load score. For example, rack assembly 1 has a relatively high total load score 451 and rack assembly 2 has a relatively low total load score 452. Further, total load scores for rack assemblies 3 on up to N fall between the total load scores of rack assemblies 1 and 2. For example, rack assembly 3 has a total load score 453 and rack assembly N has a total load score 454. As will be described below, rack assemblies between rack assembly 3 and rack assembly N mostly have total load scores below a threshold load score 430. Also, rack assembly N+1 has a relatively high total load score 455, that exceeds the threshold load score 430.

Threshold load score 430 indicates a predetermined value under which a total load score for a rack assembly should not exceed when performing load balancing. For example, when allocating a new gaming session to rack assemblies of one or more data centers, the application supporting the new gaming session is allocated to a compute node of a rack assembly that, in part, has a total load score falling below the threshold load score 430 after accounting for the new gaming session, in one embodiment. In particular, performing load balancing to assign the new gaming session of the requested application includes determining a total load score for the rack assembly under consideration based on load score(s) of gaming session(s) of application(s) executing on the considered rack assembly. The new gaming session can be assigned to the considered rack assembly after determining that the total load score for the rack assembly is below a threshold total load score. For example, each of the total load scores for the rack assemblies in group 425 of rack assemblies fall below the threshold load score 430. That is, each of total load scores 451, 452, 453 . . . 454 of rack assemblies 1 through N fall below the threshold load score 430.

In other embodiments, the threshold load score 430 should not be exceeded before accounting for the new gaming session, and as such, after assigning a gaming session to a rack assembly, that rack assembly may now have a total load score that exceeds the threshold load score 430.

Final assignment of a gaming session to a rack assembly may be determined after performing additional load balancing considerations, such as minimizing the load across all network storage of rack assemblies. For example, one goal is to minimize the maximum spread 470 between the total load scores of the rack assemblies when performing load balancing. As such, a plurality of total load scores for the plurality of rack assemblies is determined, wherein each rack assembly has a corresponding total load score based on load scores of gaming sessions of applications executing on the corresponding rack assembly. That is, the maximum spread 470 is determined from a minimum total load score of the group of rack assemblies 425 and a maximum total load score. As shown, the minimum total load score is defined by line 460b and is associated with the total load score 452 of rack assembly 2. Also, the maximum total load score is defined by line 460a and is associated with the total load score 451 of rack assembly 1. When performing load balancing, the maximum spread 470 is to be minimized, such that when assigning a new gaming session, the allocation of the corresponding application is performed with the goal of minimizing the maximum spread 470.

In another embodiment, when performing load balancing, the average spread between any two rack assemblies is minimized That is, a plurality of spread values is determined between each combination of total load scores corresponding to pairs of rack assemblies. As such, when performing load balancing to assign a new gaming session, the allocation of the corresponding application is performed with the goal of minimizing the average spread between any two rack assemblies.

As shown, line 440 defines rack assemblies that are considered for load balancing, including rack assemblies 1-N of the group of rack assemblies 425. Rack assemblies N+1 and others to the right of line 440 are not considered for load balancing. For example, participants of a multi-player gaming session may be associated with instances of an application executing on compute nodes that are all located within on rack assembly. In that manner, the load on network storage for each instance of the application would be similar, and as such one participant would not have an advantage over another participant because their instances are executing on different rack assemblies with different current load demands. In that case, because the instances of the application are executing on compute nodes on one rack assembly, that rack assembly may have a total load score that may exceed the threshold load score 430.

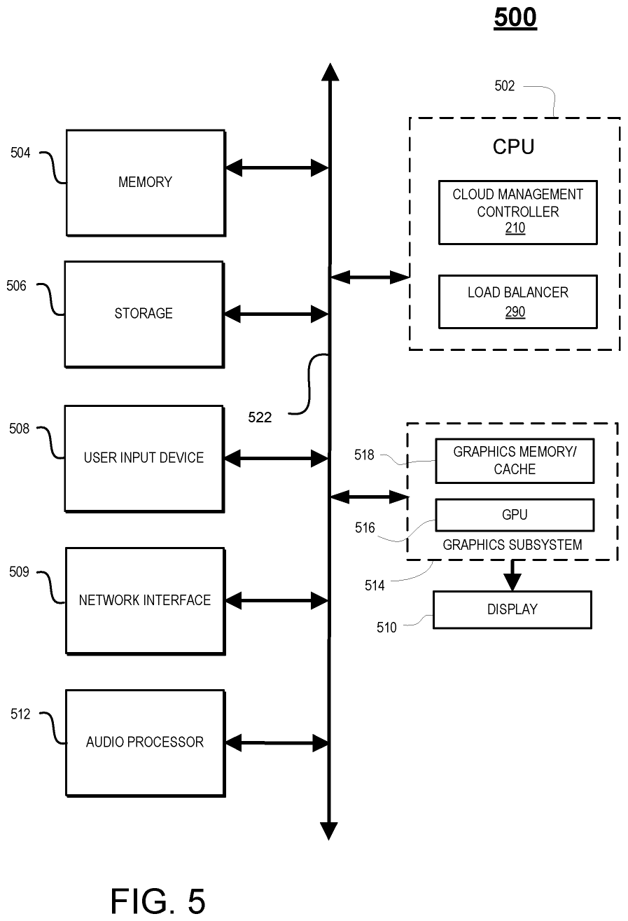

FIG. 5 illustrates components of an example device 500 that can be used to perform aspects of the various embodiments of the present disclosure. For example, FIG. 5 illustrates an exemplary hardware system suitable for learning the actual loads of a video games on network storage, assigning load scores to the video games based on the actual loads, and using the load scores to distribute video games to compute nodes of rack assemblies of one or more data centers of a game cloud system to provide for load balancing of demand on network storage of the rack assemblies, in accordance with embodiments of the present disclosure. This block diagram illustrates a device 500 that can incorporate or can be a personal computer, a server computer, gaming console, mobile device, or other digital device, each of which is suitable for practicing an embodiment of the invention. Device 500 includes a central processing unit (CPU) 502 for running software applications and optionally an operating system. CPU 502 may be comprised of one or more homogeneous or heterogeneous processing cores.

In accordance with various embodiments, CPU 502 is one or more general-purpose microprocessors having one or more processing cores. Further embodiments can be implemented using one or more CPUs with microprocessor architectures specifically adapted for highly parallel and computationally intensive applications, such as media and interactive entertainment applications, of applications configured for graphics processing during execution of a game.

In one embodiment the CPU 502 includes a cloud management controller 210 configured to assign resources to client devices, and collect and analyze data (e.g., internal data associated with the game cloud system, and external data including network data, etc.) in order to determine load scores of video games. The CPU 502 includes a load balancer 290 configured to allocate based on load scores video games to compute nodes across multiple rack assemblies of one or more data centers of a game cloud system, wherein the video games are executing to support gaming sessions of the video games. In that manner, the demand on network storage by video games executing on compute nodes can be load balanced according to a desired strategy, such as minimizing the load on each of the network storage and/or network storage servers across the rack assemblies.

Memory 504 stores applications and data for use by the CPU 502 and GPU 516. Storage 506 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 508 communicate user inputs from one or more users to device 500, examples of which may include keyboards, mice, joysticks, touch pads, touch screens, still or video recorders/cameras, and/or microphones. Network interface 509 allows device 500 to communicate with other computer systems via an electronic communications network, and may include wired or wireless communication over local area networks and wide area networks such as the internet. An audio processor 512 is adapted to generate analog or digital audio output from instructions and/or data provided by the CPU 502, memory 504, and/or storage 506. The components of device 500, including CPU 502, graphics subsystem including GPU 516, memory 504, data storage 506, user input devices 508, network interface 509, and audio processor 512 are connected via one or more data buses 522.

A graphics subsystem 514 is further connected with data bus 522 and the components of the device 500. The graphics subsystem 514 includes at least one graphics processing unit (GPU) 516 and graphics memory 518. Graphics memory 518 includes a display memory (e.g. a frame buffer) used for storing pixel data for each pixel of an output image. Graphics memory 518 can be integrated in the same device as GPU 516, connected as a separate device with GPU 516, and/or implemented within memory 504. Pixel data can be provided to graphics memory 518 directly from the CPU 502. Alternatively, CPU 502 provides the GPU 516 with data and/or instructions defining the desired output images, from which the GPU 516 generates the pixel data of one or more output images. The data and/or instructions defining the desired output images can be stored in memory 504 and/or graphics memory 518. In an embodiment, the GPU 516 includes 3D rendering capabilities for generating pixel data for output images from instructions and data defining the geometry, lighting, shading, texturing, motion, and/or camera parameters for a scene. The GPU 516 can further include one or more programmable execution units capable of executing shader programs.

The graphics subsystem 514 periodically outputs pixel data for an image from graphics memory 518 to be displayed on display device 510, or to be projected by a projection system (not shown). Display device 510 can be any device capable of displaying visual information in response to a signal from the device 500, including CRT, LCD, plasma, and OLED displays. Device 500 can provide the display device 510 with an analog or digital signal, for example.

In other embodiments, the graphics subsystem 514 includes multiple GPU devices, which are combined to perform graphics processing for a single application that is executing on a corresponding CPU. For example, the multiple GPUs can perform multi-GPU rendering of geometry for an application by pretesting the geometry against screen regions, which may be interleaved, before rendering objects for an image frame. In other examples, the multiple GPUs can perform alternate forms of frame rendering, wherein GPU 1 renders a first frame, and GPU 2 renders a second frame, in sequential frame periods, and so on until reaching the last GPU whereupon the initial GPU renders the next video frame (e.g. if there are only two GPUs, then GPU 1 renders the third frame). That is the GPUs rotate when rendering frames. The rendering operations can overlap, wherein GPU 2 may begin rendering the second frame before GPU 1 finishes rendering the first frame. In another implementation, the multiple GPU devices can be assigned different shader operations in the rendering and/or graphics pipeline. A master GPU is performing main rendering and compositing. For example, in a group including three GPUs, master GPU 1 could perform the main rendering (e.g. a first shader operation) and compositing of outputs from slave GPU 2 and slave GPU 3, wherein slave GPU 2 could perform a second shader (e.g. fluid effects, such as a river) operation, the slave GPU 3 could perform a third shader (e.g. particle smoke) operation, wherein master GPU 1 composites the results from each of GPU 1, GPU 2, and GPU 3. In that manner, different GPUs can be assigned to perform different shader operations (e.g. flag waving, wind, smoke generation, fire, etc.) to render a video frame. In still another embodiment, each of the three GPUs could be assigned to different objects and/or parts of a scene corresponding to a video frame. In the above embodiments and implementations, these operations could be performed in the same frame period (simultaneously in parallel), or in different frame periods (sequentially in parallel).

In one embodiment, a method for load balancing is disclosed. The method includes monitoring a plurality of gaming sessions of one or more applications executing across a plurality of rack assemblies; determining a plurality of load scores for the one or more applications associated with plurality of gaming sessions, wherein a corresponding load score of a corresponding application defines a functional load demand on a corresponding network storage; and load balancing the plurality of gaming sessions of the one or more applications based on the plurality of load scores associated with the one or more applications facilitating the plurality of gaming sessions.

The method further includes measuring load demands of a plurality of applications between a plurality of compute nodes and a plurality of network storage distributed across a plurality of rack assemblies of one or more data centers; for each application in the plurality of applications, determining a corresponding functional load demand based on load demands that are measured for the each application between the plurality of compute nodes and the plurality of network storage; and assigning a load score to each of the plurality of applications based on a plurality of functional load demands determined for the plurality of applications. Further, the corresponding functional load demand is an average load demand

In one embodiment, the operation of measuring load demands of the plurality of applications includes monitoring data traffic over a plurality of communication channels between the plurality of compute nodes and the plurality of network storage, wherein the data traffic is monitored during at least one of a start-up loading period, or a level loading period, or an operation period, or an updating period for a corresponding application.

In another embodiment, the method includes receiving a request for a new gaming session of a requested application, wherein the new gaming session is included within the plurality of gaming sessions that is load balanced; and assigning the new gaming session of the requested application to a compute node of a rack assembly based on the load balancing.

In another embodiment, the assigning the new gaming session of the requested application includes determining a total load score for the rack assembly based on one or more load scores of one or more gaming sessions of one or more applications executing on the rack assembly; and determining that the total load score for the rack assembly is below a threshold total load score.

In another embodiment, the load balancing includes determining a plurality of total load scores for the plurality of rack assemblies, wherein each rack assembly has a corresponding total load score based on one or more load scores of one or more gaming sessions of one or more applications executing on the each rack assembly; determining a maximum spread of load scores between any two rack assemblies of the plurality of rack assemblies; and minimizing the maximum spread of load scores

In another embodiment, the load balancing includes determining a plurality of total load scores for the plurality of rack assemblies, wherein each rack assembly has a corresponding total load score based on one or more load scores of one or more gaming sessions of one or more applications executing on the each rack assembly; and ensuring that each of the plurality of total load scores is below a threshold total load score.

Accordingly, the present disclosure describes methods and systems configured for learning the load of video games on network storage of rack assemblies, assign load scores to video games based on the learned loads, and allocating video games throughout a game cloud system based on the load scores to load balance demand for network storage across the rack assemblies by the video games executing on compute nodes on the rack assemblies.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

With the above embodiments in mind, it should be understood that embodiments of the present disclosure can employ various computer-implemented operations involving data stored in computer systems. These operations are those requiring physical manipulation of physical quantities. Any of the operations described herein that form part of embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The disclosure can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing disclosure has been described in some detail for purposes of clarity of understanding, it will be apparent that certain changes and modifications can be practiced within the scope of the appended claims. Accordingly, the present embodiments are to be considered as illustrative and not restrictive, and embodiments of the present disclosure is not to be limited to the details given herein, but may be modified within the scope and equivalents of the appended claims.

What is claimed is:

1. A method, comprising:
measuring load demands of a plurality of applications between a plurality of compute nodes and a plurality of network storage distributed across a plurality of rack assemblies of one or more data centers;
for each application in the plurality of applications, determining a functional load demand based on load demands that are measured for the each application between the plurality of compute nodes and the plurality of network storage;
assigning a load score to each of the plurality of applications based on a plurality of functional load demands determined for the plurality of applications; and
load balancing a plurality of gaming sessions of one or more applications executing across the plurality of rack assemblies based on a plurality of load scores associated with the one or more applications facilitating the plurality of gaming sessions.

2. The method of claim 1,
wherein the functional load demand comprises an average load demand

3. The method of claim 1, wherein the measuring the load demands of the plurality of applications includes:
monitoring data traffic over a plurality of communication channels between the plurality of compute nodes and the plurality of network storage.

4. The method of claim 3, wherein the data traffic is monitored during at least one of a start-up loading period, or a level loading period, or an operation period, or an updating period for a corresponding application.

5. The method of claim 1, wherein the load balancing the plurality of gaming sessions includes:
monitoring the plurality of gaming sessions across the plurality of rack assemblies;
determining a corresponding load score associated with each of the plurality of gaming sessions, wherein a corresponding application executing to facilitate a corresponding gaming session in the plurality of gaming session is assigned the corresponding load score, wherein the corresponding load score is associated with the corresponding gaming session; and
determining the plurality of load scores for the one or more applications associated with the plurality of gaming sessions for use when performing the load balancing.

6. The method of claim 5, further comprising:
receiving a request for a new gaming session of a requested application, wherein the new gaming session is included within the plurality of gaming sessions that is load balanced;
assigning the new gaming session of the requested application to a compute node of a rack assembly based on the load balancing.

7. The method of claim 6, wherein the assigning the new gaming session of the requested application includes:
determining a total load score for the rack assembly based on one or more load scores of one or more gaming sessions of one or more applications executing on the rack assembly; and
determining that the total load score for the rack assembly is below a threshold total load score.

8. The method of claim 5, wherein the load balancing includes:
determining a plurality of total load scores for the plurality of rack assemblies, wherein each rack assembly has a corresponding total load score based on one or more load scores of one or more gaming sessions of one or more applications executing on the each rack assembly;
determining a maximum spread of load scores between any two rack assemblies of the plurality of rack assemblies; and
minimizing the maximum spread of load scores.

9. The method of claim 5, wherein the load balancing includes:
determining a plurality of total load scores for the plurality of rack assemblies, wherein each rack assembly has a corresponding total load score based on one or more load scores of one or more gaming sessions of one or more applications executing on the each rack assembly; and
ensuring that each of the plurality of total load scores is below a threshold total load score.

10. The method of claim 1, further comprising:
predicting a plurality of predicted gaming sessions of one or more predicted applications across the plurality of rack assemblies;
determining a predicted load score associated with each of the plurality of predicted gaming sessions, wherein a corresponding predicted application executing to facilitate a corresponding predicted gaming session has a corresponding predicted load score that is assigned to the corresponding predicted gaming session;
determining a plurality of predicted load scores associated with the plurality of predicted gaming sessions; and
load balancing the plurality of predicted gaming sessions across the plurality of rack assemblies based on the plurality of predicted load scores.

11. A non-transitory computer-readable medium storing a computer program for performing a method, the computer-readable medium comprising:
program instructions for measuring load demands of a plurality of applications between a plurality of compute nodes and a plurality of network storage distributed across a plurality of rack assemblies of one or more data centers;
program instructions for determining a functional load demand for each application in the plurality of applications based on load demands that are measured for the each application between the plurality of compute nodes and the plurality of network storage;
program instructions for assigning a load score to each of the plurality of applications based on a plurality of functional load demands determined for the plurality of applications; and
program instructions for load balancing a plurality of gaming sessions of one or more applications executing across the plurality of rack assemblies based on a plurality of load scores associated with the one or more applications facilitating the plurality of gaming sessions.

12. The non-transitory computer-readable medium of claim 11, wherein the program instructions for measuring the load demands of the plurality of applications includes:
program instructions for monitoring data traffic over a plurality of communication channels between the plurality of compute nodes and the plurality of network storage.

13. The non-transitory computer-readable medium of claim 11, wherein the program instructions for load balancing the plurality of gaming sessions includes:
program instructions for monitoring the plurality of gaming sessions across the plurality of rack assemblies;
program instructions for determining a corresponding load score associated with each of the plurality of gaming sessions, wherein a corresponding application executing to facilitate a corresponding gaming session in the plurality of gaming session is assigned the corresponding load score, wherein the corresponding load score is associated with the corresponding gaming session; and
program instructions for determining the plurality of load scores for the one or more applications associated with the plurality of gaming sessions for use when performing the load balancing.

14. The non-transitory computer-readable medium of claim 13, wherein the program instructions for load balancing includes:
program instructions for determining a plurality of total load scores for the plurality of rack assemblies, wherein each rack assembly has a corresponding total load score based on one or more load scores of one or more gaming sessions of one or more applications executing on the each rack assembly;
program instructions for determining a maximum spread of load scores between any two rack assemblies of the plurality of rack assemblies; and
program instructions for minimizing the maximum spread of load scores.

15. The non-transitory computer-readable medium of claim 13, wherein the program instructions for load balancing includes:
program instructions for determining a plurality of total load scores for the plurality of rack assemblies, wherein each rack assembly has a corresponding total load score based on one or more load scores of one or more gaming sessions of one or more applications executing on the each rack assembly; and
program instructions for ensuring that each of the plurality of total load scores is below a threshold total load score.

16. A computer system comprising:
a processor;
memory coupled to the processor and having stored therein instructions that, if executed by the computer system, cause the computer system to execute a method comprising:
measuring load demands of a plurality of applications between a plurality of compute nodes and a plurality of network storage distributed across a plurality of rack assemblies of one or more data centers;
for each application in the plurality of applications, determining a functional load demand based on load demands that are measured for the each application between the plurality of compute nodes and the plurality of network storage;
assigning a load score to each of the plurality of applications based on a plurality of functional load demands determined for the plurality of applications; and
load balancing a plurality of gaming sessions of one or more applications executing across the plurality of rack assemblies based on a plurality of load scores associated with the one or more applications facilitating the plurality of gaming sessions.

17. The computer system of claim 16, wherein in the method the measuring the load demands of the plurality of applications includes:
monitoring data traffic over a plurality of communication channels between the plurality of compute nodes and the plurality of network storage.

18. The computer system of claim 16, wherein in the method the load balancing the plurality of gaming sessions includes:
monitoring the plurality of gaming sessions across the plurality of rack assemblies;
determining a corresponding load score associated with each of the plurality of gaming sessions, wherein a corresponding application executing to facilitate a corresponding gaming session in the plurality of gaming session is assigned the corresponding load score, wherein the corresponding load score is associated with the corresponding gaming session; and
determining the plurality of load scores for the one or more applications associated with the plurality of gaming sessions for use when performing the load balancing.

19. The computer system of claim 18, wherein in the method the load balancing includes:
determining a plurality of total load scores for the plurality of rack assemblies, wherein each rack assembly has a corresponding total load score based on one or more load scores of one or more gaming sessions of one or more applications executing on the each rack assembly;
determining a maximum spread of load scores between any two rack assemblies of the plurality of rack assemblies; and
minimizing the maximum spread of load scores.

20. The computer system of claim 18, wherein in the method the load balancing includes:
determining a plurality of total load scores for the plurality of rack assemblies, wherein each rack assembly has a corresponding total load score based on one or more load scores of one or more gaming sessions of one or more applications executing on the each rack assembly; and
ensuring that each of the plurality of total load scores is below a threshold total load score.
